(19) United States
(12) Patent Application Publication
(10) Pub. No.: US 2017/0104380 A1
(43) Pub. Date: Apr. 13, 2017

(54) SLOT LINER THERMAL CONDUCTIVITY FOR ELECTRIC MOTORS

(71) Applicant: UQM TECHNOLOGIES, INC., Longmont, CO (US)

(72) Inventors: John TEACHNOR, Longmont, CO (US); Josh LEY, Erie, CO (US); Victor CHIEDUKO, Arvada, CO (US); Jake DAWSON, Thornton, CO (US); David DOUTRE, Brighton, CO (US)

(73) Assignee: UQM TECHNOLOGIES, INC., Longmont, CO (US)

(21) Appl. No.: 14/950,276

(22) Filed: Nov. 24, 2015

Related U.S. Application Data
(60) Provisional application No. 62/258,752, filed on Nov. 23, 2015.
(60) Provisional application No. 62/239,024, filed on Oct. 8, 2015.

(51) Int. Cl. H02K 3/34; H02K 9/22

(52) U.S. Cl. CPC H02K 3/345; H02K 9/22

(57) ABSTRACT

An electric machine includes a stator having a stator core, rotor core and/or magnetic core comprising a plurality of slots. Each of the plurality of slots includes a spacer, a conductor, and encapsulated slot insulation. The spacer is configured to suspend the conductor away from the stator core by a dielectric distance without occupying all of the space between the conductor and the stator core. The encapsulated slot insulation includes an encapsulation material configured to flow in a liquid state around the perimeter of the conductor filling in the space between the conductor and the stator core. The encapsulation material cures to hold the spacer and the conductor in place. The encapsulated material typically has higher thermal conductivity properties than a conventional slot liner, increasing the performance of the motor.

### RELATED APPLICATIONS

This application claims the benefit under 35 U.S.C. §119 of U.S. Provisional Patent No. 62/239,024 filed on Oct. 8, 2015 and U.S. Provisional Patent No. 62/258,752 filed on Nov. 23, 2015, the entire contents of which are hereby incorporated by reference in their entireties.

### FIELD

The present disclosure relates to the field of high performance electric motors. More particularly, the present disclosure relates to construction of an encapsulated slot insulation for a stator and/or rotor of the electric motor which permits efficient removal of heat from the motor.

### BACKGROUND INFORMATION

The traditional method of electrically insulating a conductor from a rotor or stator core material is achieved with a component commonly referred to as a “slot liner”. Slot liners are used in the stators and/or rotors of electric machines, such as generators and/or motors, to provide insulation between the stator core and/or rotor core and the stator windings and/or rotor windings. The slot liner will separate stator windings, placed in the slots of a stator core, from the stator core. The slot liner will similarly separate rotor windings from the rotor core.

The slot liner is typically made up of thin electrically insulating materials such as nomex or mylar. There are a number of different materials including composites of different materials such as NMN (nomex-mylar-nomex) and DMD (Dacron-mylar-Dacron) that are commonly used as slot liners. The materials mentioned are a small collection of a myriad of potential materials manufactured for this purpose. Most of these materials have a relatively low thermal conductivity. When operating, the slot liner provides electrical insulation of the stator windings from the core, while allowing heat generated in the stator windings, to transfer from the stator windings to the stator core.

In many motor designs, the soft magnetic materials that make up the stator and/or rotor core, have a plurality of slots employed to house the electrical conductors used to carry the electrical current in the motor. These soft magnetic materials in a stator and/or rotor are also known as a stator core, rotor core or magnetic cores. In most instances the materials used to insulate the slot in the rotor core is manufactured as a thin sheet. It is then cut and sometimes formed to fit the shape of a rotor and/or stator slot in an electric machine. This thin sheet of insulating material then protects and insulates the electrical conductors within the stator and/or rotor of an electric machine.

This method of insulating the conductors from the stator and/or rotor core is usually from a material having poor thermal conducting capabilities. Thus, it is desirable to eliminate this traditional slot liner made from a sheet of insulation material that is normally a poor thermal conducting material.

### SUMMARY

Exemplary embodiments of the present disclosure provide for the elimination of the traditional slot liner usually composed of a poor thermal conducting material that is cut from a thin sheet then inserted into the magnetic core. The disclosed embodiments use the winding encapsulating material to fill the space normally occupied by the slot liner sheet material. The same practice can also be found in the rotor core for wound rotors as well as stator cores within stators. This disclosure applies to both cases, rotor cores and stator cores. For instance, exemplary embodiments of the present disclosure provide an electrical machine comprising a stator having a stator core comprising a plurality of slots. Each of the plurality of slots comprises a spacer, a conductor, and/or an encapsulated slot insulation. The spacer is configured to suspend the conductor away from the stator core by an appropriate dielectric distance without occupying all of the space between the conductor and the stator core. The encapsulated slot insulation comprises an encapsulation material configured to flow in a fluid state around the perimeter of the conductor filling in the space between the conductor and the stator core. The encapsulation material cures and hardens to hold the spacer and the conductor in place. The fluid state of the encapsulation material can take on a variety of viscosities and there are numerous known methods of making the encapsulation material flow into the winding and slot.

An exemplary embodiment of the present disclosure provides an electrical machine comprising a stator having a stator core comprising a plurality of slots. Each of the plurality of slots comprises a plurality of spacers, a conductor, and/or an encapsulated slot insulation. The plurality of spacers is configured to suspend the conductor away from the stator core by a dielectric distance without occupying all of the space between the conductor and the stator core. The encapsulated slot insulation comprises an encapsulation material configured to flow in a fluid state around the perimeter of the conductor filling in the space between the conductor and the stator core. The encapsulation material cures to hold the plurality of spacers and the conductor in place.

An exemplary embodiment of the present disclosure provides an electrical machine comprising a stator having a stator core comprising a plurality of slots. Each of the plurality of slots comprises a plurality of spacers, a plurality of conductors, and/or an encapsulated slot insulation. The plurality of spacers are configured to suspend the plurality of conductors away from the stator core by a dielectric distance without occupying all of the space between the plurality of conductors and the stator core. The encapsulated slot insulation comprises an encapsulation material configured to flow in a liquid state around the perimeter of the plurality of conductors filling in the space between the plurality of conductors and the stator core. The encapsulation material cures to hold the plurality of spacers and the plurality of conductors in place.

### BRIEF DESCRIPTION OF THE DRAWINGS

Additional refinements, advantages and features of the present disclosure are described in more detail below with reference to exemplary embodiments illustrated in the drawings, in which:

FIGS. 1A, 1B, and 1C illustrate slot liners cut or formed from sheets according to known art;

FIG. 2 illustrates an encapsulated slot insulation according to an exemplary embodiment of the present disclosure;

FIG. 3 illustrates an encapsulated slot insulation with multiple conductors (2 depicted, more are possible via replication) according to an exemplary embodiment of the present disclosure;

FIG. 4 illustrates an encapsulated slot insulation with the insulating spacer(s) pre-applied to the conductor according to an exemplary embodiment of the present disclosure;

FIG. 5 illustrates an encapsulated slot insulation with a screen or perforated slot liner according to an exemplary embodiment of the present disclosure.

In the drawings, similar components and/or similarly-functioning components are denoted with the same reference number. Various features depicted in the drawings are not drawn to scale for better understanding of the features of the present disclosure.

### DETAILED DESCRIPTION

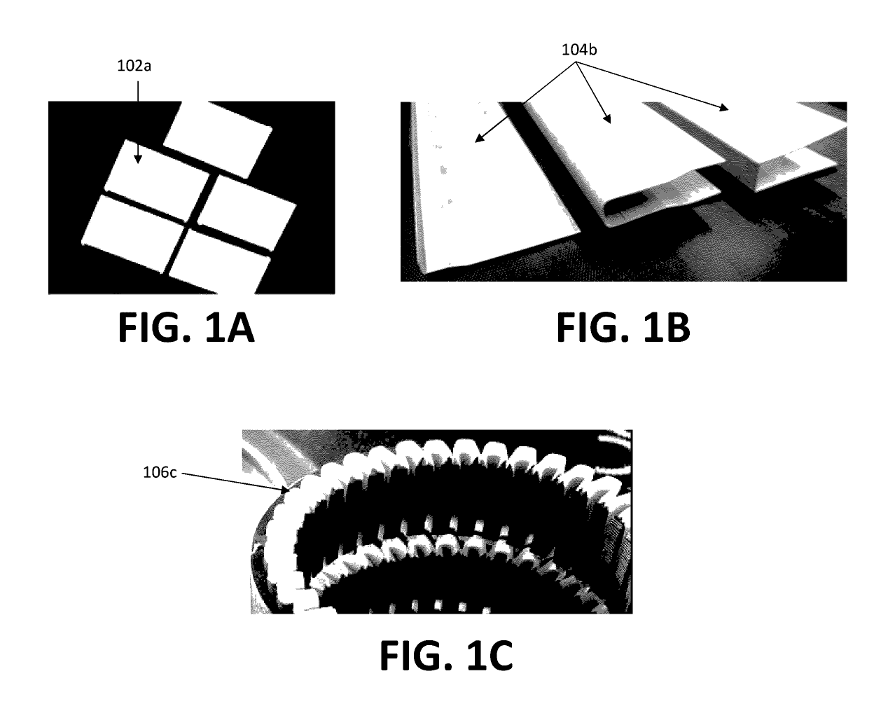

FIGS. 1A, 1B, and 1C illustrate conventional slot liners cut or formed from sheets according to an embodiment of the prior art. The standard method of electrically insulating the conductor from the rotor and/or stator core material is achieved with a component commonly referred to as a “slot liner”. The slot liner is typically made up of thin electrically insulating materials such as nomex or mylar. There are a number of different materials including composites if different materials such as NMN (nomex-mylar-nomex) and DMD (Dacron-mylar-Dacron) that are commonly used as slot liners. The materials mentioned are an exemplary collection of a myriad of potential materials manufactured for this purpose. Most of these materials have a relatively low thermal conductivity.

In most motor designs the soft magnetic materials that make up the stator and/or rotor core, have a plurality of slots 106c employed to house the electrical conductors used to carry the electrical current in the motor. These soft magnetic materials in a stator and/or rotor are also known as a stator core, rotor core or magnetic core. In most instances the materials used to insulate the slot in the rotor core is manufactured as a thin sheet 102a. It is then cut and sometimes formed 104b to fit the shape of a rotor and/or stator slot in an electric machine. This thin sheet 102a of insulating material then protects and insulates the electrical conductors within the stator and/or rotor of an electric machine. This method of insulating the conductors from the stator and/or rotor core is typically from a material having poor thermal conducting capabilities.

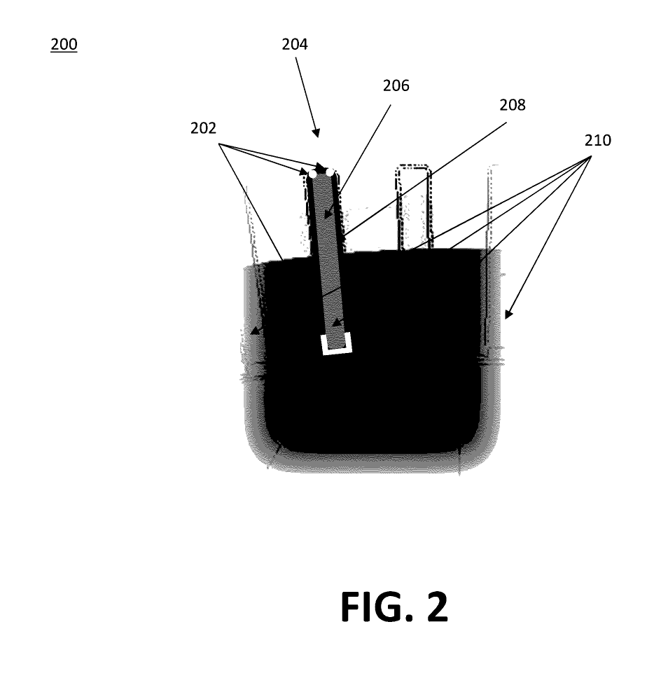

FIG. 2 illustrates an encapsulated slot insulation in a stator 200 according to an exemplary embodiment of the present disclosure. This implementation may also be applied to a rotor. An electrical machine comprises: a stator 200 which includes a spacer or set of spacers 202, a stator core 204, a conductor 206, an encapsulated slot insulation 208, and/or a plurality of slots 210. The stator 200 may have a stator core 204 comprising a plurality of slots 210. Each of the plurality of slots 210 may comprise a spacer 202, a conductor 206, and an encapsulated slot insulation 208.

The spacer 202 comprises a plurality of spacers. In some implementations, the spacer 202 is one or more beads, discrete rods, and/or any other shape of electrically insulating material. In some implementations, the spacer 202 is applied to the conductor 206 before the conductor 206 is inserted into the slot 210. In some implementations, the spacer 202 is applied to the conductor 206 after the conductor 206 is inserted into the slot 210. The spacer 202 is configured to suspend the conductor 206 away from the stator core 204 by a dielectric distance without occupying all of the space between the conductor 206 and the stator core 204. Spacers 202 are set for proper clearance from stator core 204.

The conductor 206 may comprise of a plurality of conductors 206. In some implementations, the conductor 206 is a copper bar, a plurality of copper bars, or a plurality of individually insulated stranded copper wires, and/or made from any other electrically conductive material.

The encapsulated slot insulation 208 may comprise an encapsulation material configured to flow in a liquid state around the perimeter of the conductor 206 filling in the space between the conductor 206 and the stator core 204. In the manufacturing process the encapsulation material is a fluid that is pushed, pulled and/or wicked into the winding using a variety of methods. The encapsulation material then hardens and/or cures around the winding. The encapsulation material cures to hold the spacer 202 and the conductor 206 in place. In some implementations, the encapsulation material is at least one of: a varnish, a polyester resin, an organic resin, an inorganic resin, an epoxy, a silicone based material, aluminum oxide, a myriad of other filler materials which increase thermal conductivity and/or a filler material embedded into a resin material.

The encapsulation material is often filled with a thermally conductive material, giving it good thermal conducting properties. The encapsulation material is used to fill the voids between the winding conductors 206 for added insulation and strength in the motor winding. In some implementations, the encapsulation materials have thermal conductivity which is 10 to 30 times the thermal conductivity of the sheet materials normally composing the slot insulation as in FIGS. 1A, 1B and 1C. The encapsulation material is utilized to fill the space previously occupied by the sheet slot liner material, thus eliminating the need for conventional slot liner material. In some implementations, the encapsulation material is 10 to 30 times more thermally conductive than conventional slot liners. This enables better heat flow out of the slot leading to much improved power and torque density for a new design and/or a continuous power or torque increase for an existing design. By using a higher thermal conductivity encapsulation material, the encapsulated slot insulation has a much higher thermal conductivity than the usual sheet type slot liner. This arrangement will therefore allow heat to dissipate from the conductor more efficiently and provide a higher performing and cooler running motor.

In an exemplary embodiment, when the conductor 206 comprises solid copper bar windings, many different embodiments may be implemented. The challenge is to consistently and accurately space the copper bar from the magnetic core by the intended distance while allowing the encapsulation material to flow around the copper bar during the manufacturing process. The encapsulation material subsequently hardens in place around the copper bar, forming the encapsulated slot insulation 208. Many different implementations and component arrangements can be realized as a means of suspending the copper bar within the magnetic core during the encapsulation process. Thermally conductive encapsulation materials are normally forced into the winding and magnetic core using pressure and/or vacuum, therefore the means of suspending the conductors should be robust enough to resist those forces of injecting the encapsulation material.

One method of suspending the solid copper bar conductor is to utilize discrete rods of electrically insulating material shaped in such a way that the conductor 206 is spaced away from the magnetic core material. In addition to the shaped insulating rod material, the copper bar conductors and/or the magnetic core material may have discrete features to keep the copper bar position correctly within the slot of the magnetic core. It is desirable for the electrically insulating components used to suspend the conductor to be discrete, such that they occupy less of the perimeter of the slot. This will allow the higher thermal conductivity encapsulation material to occupy more of the perimeter of the slot, thus allowing greater thermal performance.

In another exemplary embodiment, the solid copper bar conductors are suspended by applying and/or adhering an electrically insulating material to the copper bar in discrete locations prior to inserting the conductor into the slot. In this case it is also desirable for the adhered electrically insulating material to occupy as little of the perimeter as possible such that the higher thermally conducting material may occupy more of the perimeter and allow a higher thermal performance. In an exemplary embodiment, the copper bar is a conductor made from any conductive material.

For either exemplary embodiments above, with either adhered and/or feature oriented suspension components, a number of different embodiment geometries may be implemented and the spirit of all each of these geometries are covered herein.

In addition to the methods disclosed above for suspending a conductor (e.g., solid copper bar), another method can also be realized where the conductor (e.g., solid copper bar) is held fixed outside the magnetic core, in such a way that it does not completely impede the flow of encapsulation material during the encapsulation process. This method will require both the conductor (e.g., solid copper bar) and the slot feature of the stator core to remain very straight throughout the length of the conductor's location within the core to maintain consistent spacing between the conductor and the core. This method has the potential to yield a high performing motor, due to the ability to allow the entire perimeter of the conductor to be surrounded by encapsulation materials.

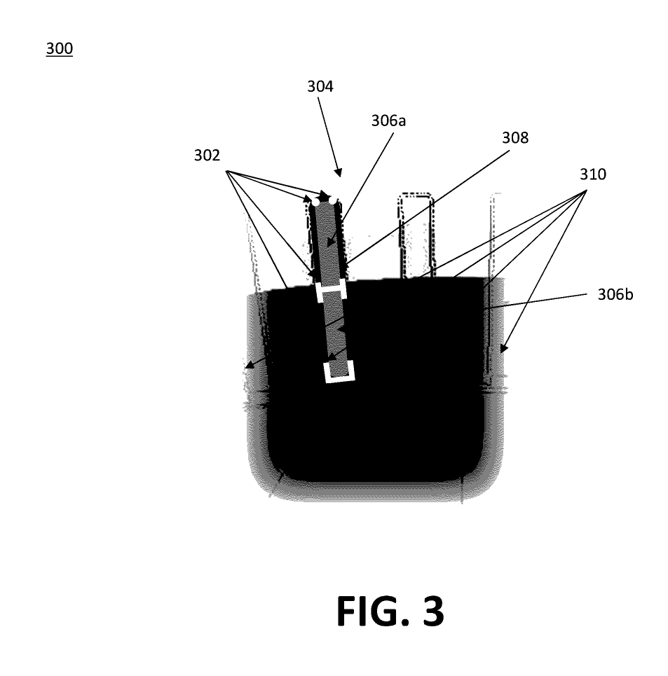

FIG. 3 illustrates an encapsulated slot insulation with multiple conductors 306a, 306b in a stator 300 according to an exemplary embodiment of the present disclosure. This implementation may also be applied to a rotor.

An electrical machine comprises a stator 300 having a stator core 304 comprising a plurality of slots 310. Each of the plurality of slots 310 comprises a plurality of spacers 302, a plurality of conductors 306a, 306b, and an encapsulated slot insulation 308.

In some implementations, the spacers 302 are set at a proper clearance from the stator 300 for the intended operating voltage in an application. In some implementations spacers 302 are set at a clearance between bars for multiple conductors 306a, 306b.

The conductors 306a, 306b are one or more of: copper bars, individually insulated stranded copper wire and/or be made of any conductive material. Any number of conductors is possible.

In some implementations, the plurality of spacers 302 are configured to suspend the plurality of conductors 306a, 306b away from the stator core 304 by a dielectric distance without occupying all of the space between the plurality of conductors 306a, 306b, and the stator core 304. Many different spacer shapes are possible, as long as they allow the encapsulation material to flow into the slot.

The encapsulated slot insulation 308 may comprise an encapsulation material configured to flow in a fluid state around the perimeter of the plurality of conductors 306a, 306b filling in the space between the plurality of conductors 306a, 306b and the stator core 304. In some implementations, the encapsulation material may cure and/or harden to hold the plurality of spacers and the plurality of conductors in place.

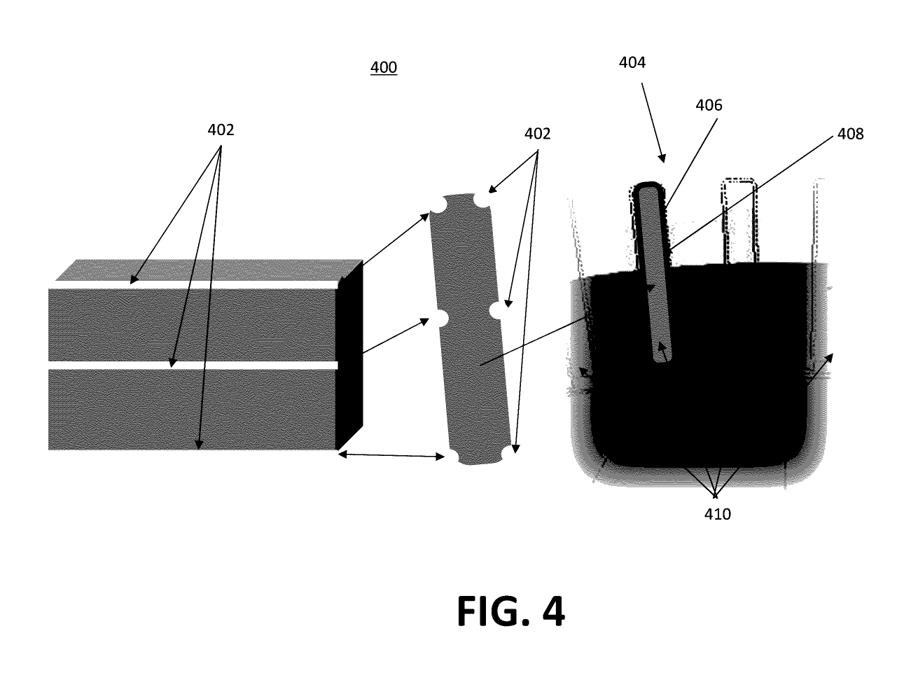

FIG. 4 illustrates an encapsulated slot insulation with insulation pre-applied to the conductor 406 in a stator 400 according to an exemplary embodiment of the present disclosure according to an exemplary embodiment of the present disclosure. This implementation may also be applied to a rotor.

An electrical machine comprising a stator 400 having a stator core 404 comprising a plurality of slots 410. Each of the plurality of slots 410 comprises a plurality of spacers 402, a conductor 406, and an encapsulated slot insulation 408. The plurality of spacers 402 are configured to suspend the conductor 406 away from the stator core 404 by a dielectric distance without occupying all of the space between the conductor 406 and the stator core 404. The encapsulated slot insulation 408 comprises an encapsulation material configured to flow in a liquid state around the perimeter of the conductor 406 filling in the space between the conductor 406 and the stator core 404. The encapsulation material may cure to hold the plurality of spacers 402 and the conductor 406 in place. In some implementations, conductor 406 is a copper bar. In some implementations, the conductor 406 comprises a plurality of copper bars. In some implementations, the conductor 406 is an individually insulated stranded copper wire.

In some implementations, the plurality of spacers 402 may be one or more of beads and/or rods. The plurality of spacers 402 are applied to the conductor 402 before the conductor 402 is inserted into the slot 410. In some implementations, the plurality of spacers 402 are applied to the conductor 406 after the conductor 406 is inserted into the slot 410. The spacer 402 may comprise a plurality of spacers. The spacers 402 are set for proper clearance from stator 400 for the voltage of operation. The spacers 402 may be beads and/or rod adhered to the conductor 406 (e.g., copper). Many different spacer locations and materials having electrically insulating properties may be implemented. The encapsulation material used as the encapsulated slot insulation 408 is at least one of: a varnish, a polyester resin, an organic resin, an inorganic resin, an epoxy, and a silicone based material. In some implementations, the material is applied as a fluid then hardened.

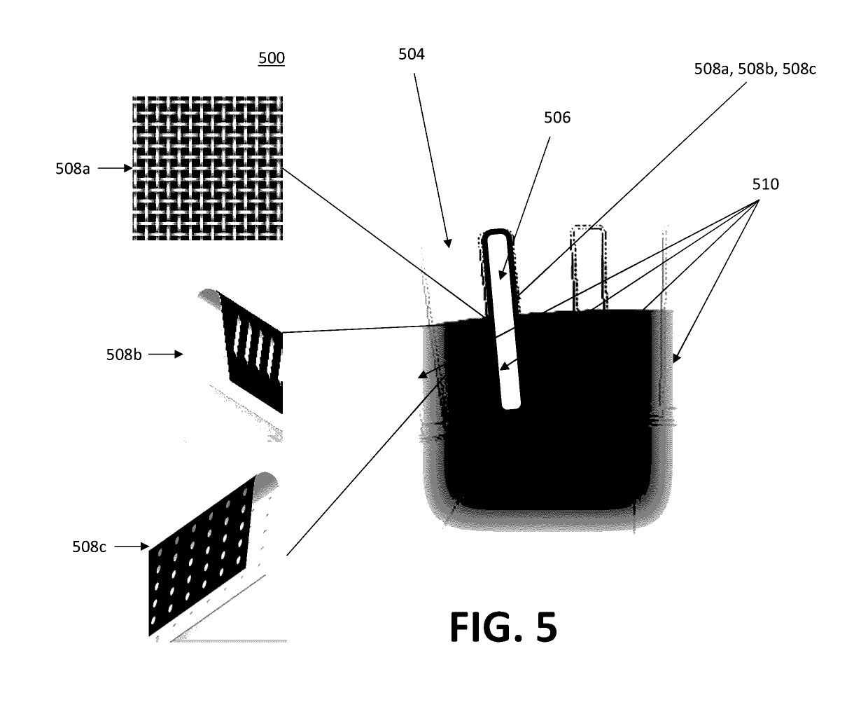

FIG. 5 illustrates the afore-mentioned encapsulated slot insulation with an electrically insulating screen mesh 508a or perforated slot liner such as a punched slot liner 508b which may have any shape or density of perforation, and/or a perforated slot liner 508c which may also have any shape or density of perforation in a stator 500 according to an exemplary embodiment of the present disclosure. This implementation may also be applied to a rotor.

In some implementations, the screen 508a or perforated slot liners 508b, 508c may comprise dielectric spacing. The encapsulation material, which is applied to the conductor 506 (e.g. stranded wire and/or copper bar windings) may be a fluid material used fill a space between conductor 506 and stator core 504. The holes must be small enough to disallow encroachment of stranded wire, but maximized hole density is preferred to allow maximum encapsulation material in contact with the conductor and core material.

This encapsulated slot insulation process can also be accomplished with stranded wire within a slot. Stranded wire can be composed of round wire, square, rectangular or any other shape where several individual insulated wires occupy a slot within a magnetic core. The method of encapsulating stranded wire will require installing a mesh 508a around the perimeter of the slot 510 or around the wire before being inserted into the slot 510. The mesh 508a must be of the required thickness and density to space the stranded wire the required distance from the stator core 504 material. During the encapsulation process the liquefied encapsulation material will flow through the mesh 508a and around the stranded wires creating an encapsulated slot insulation 506 after the encapsulation material cures. The mesh 508a must be of high enough density to impede the stranded wires from intruding into the required dielectric spacing between the wire and the stator core 504. However for better performance the mesh 508a should be the lowest material density required to achieve the proper dielectric distance, such that more encapsulation material occupies the space between the stranded wire and the magnetic core. The mesh 508a must also allow the encapsulation material to flow into the area between the windings and core during the encapsulation process.

The mesh 508a material can be made of any electrically insulating material having the ability and strength to stay in place while injecting the encapsulation material. It must also have the stiffness and mechanical strength necessary to hold position while the stranded wires is being inserted into the slot using any of the known methods.

The methods described above pertains to making encapsulation material to flow around a conductor 506 (e.g., copper bar) during the encapsulation process by forming a high thermal conductivity encapsulated slot insulation after the encapsulation material cures.

The exemplary stator architecture of the present disclosure may also be applied to rotors in an electric machine. While the present disclosure has been illustrated and described in detail in the drawings and foregoing description, such illustration and description are to be considered illustrative or exemplary and not restrictive. The present disclosure is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An electric machine comprising:
a stator having a stator core comprising a plurality of slots;
each of the plurality of slots comprising a spacer, a conductor, and an encapsulated slot insulation,
wherein the spacer is configured to suspend the conductor away from the stator core by a dielectric distance without occupying all of the space between the conductor and the stator core,
wherein the encapsulated slot insulation comprises an encapsulation material configured to flow in a liquid state around the perimeter of the conductor filling in the space between the conductor and the stator core, and
wherein the encapsulation material cures to hold the spacer and the conductor in place.

2. The electric machine of claim 1, wherein the conductor is a copper bar.

3. The electric machine of claim 1, wherein the conductor comprises a plurality of copper bars.

4. The electric machine of claim 1, wherein the conductor is individually insulated stranded copper wires.

5. The electric machine of claim 1, wherein the spacer comprises a plurality of spacers.

6. The electric machine of claim 1, wherein the spacer is one or more beads.

7. The electric machine of claim 1, wherein the spacer is one or more rods.

8. The electric machine of claim 1, wherein the spacer is applied to the conductor before the conductor is inserted into the slot.

9. The electric machine of claim 1, wherein the spacer is applied to the conductor after the conductor is inserted into the slot.

10. The electric machine of claim 1, wherein the encapsulation material is at least one of: a varnish, a polyester resin, an organic resin, an inorganic resin, an epoxy, aluminum oxide, a silicone based material, and a filler material embedded into a resin material.

11. An electric machine comprising:
a stator having a stator core comprising a plurality of slots;
each of the plurality of slots comprising a plurality of spacers, at least one conductor, and an encapsulated slot insulation,
wherein the plurality of spacers are configured to suspend the at least one conductor away from the stator core by a dielectric distance without occupying all of the space between the at least one conductor and the stator core,
wherein the encapsulated slot insulation comprises an encapsulation material configured to flow in a liquid state around the perimeter of the at least one conductor filling in the space between the at least one conductor and the stator core, and
wherein the encapsulation material cures to hold the plurality of spacers and the at least one conductor in place.

12. The electric machine of claim 11, wherein the at least one conductor is a copper bar.

13. The electric machine of claim 11, wherein the at least one conductor comprises a plurality of copper bars.

14. The electric machine of claim 11, wherein the at least one conductor is individually insulated stranded copper wire.

15. The electric machine of claim 11, wherein the plurality of spacers are beads.

16. The electric machine of claim 11, wherein the plurality of spacers are rods.

17. The electric machine of claim 11, wherein the plurality of spacers is applied to the at least one conductor before the at least one conductor is inserted into the slot.

18. The electric machine of claim 11, wherein the plurality of spacers is applied to the at least one conductor after the at least one conductor is inserted into the slot.

19. The electric machine of claim 11, wherein the encapsulation material is at least one of: a varnish, a poly-ester resin, an organic resin, an inorganic resin, an epoxy, aluminum oxide, a silicone based material, and a filler material embedded into a resin material.

20. An electrical machine comprising:
a stator having a stator core comprising a plurality of slots;
each of the plurality of slots comprising a plurality of spacers, a plurality of conductors, and encapsulated slot insulation,
wherein the plurality of spacers are configured to suspend the plurality of conductors away from the stator core by a dielectric distance without occupying all of the space between the plurality of conductors and the stator core,
wherein the encapsulated slot insulation comprises an encapsulation material configured to flow in a liquid state around the perimeter of the plurality of conductors filling in the space between the plurality of conductors and the stator core, and
wherein the encapsulation material cures to hold the plurality of spacers and the plurality of conductors in place.

21. An electric machine comprising:
a rotor having a rotor core comprising a plurality of slots;
each of the plurality of slots comprising a spacer, at least one conductor, and an encapsulated slot insulation,
wherein the spacer is configured to suspend the at least one conductor away from the rotor core by a dielectric distance without occupying all of the space between the at least one conductor and the rotor core,
wherein the encapsulated slot insulation comprises an encapsulation material configured to flow in a liquid state around the perimeter of the at least one conductor filling in the space between the at least one conductor and the rotor core, and
wherein the encapsulation material cures to hold the spacer and the at least one conductor in place.

22. The electric machine of claim 21, wherein the encapsulation material is at least one of: a varnish, a poly-ester resin, an organic resin, an inorganic resin, an epoxy, aluminum oxide, a silicone based material, and a filler material embedded into a resin material.

23. The electric machine of claim 21, wherein the spacer is one or more beads.

24. The electric machine of claim 21, wherein the spacer is one or more rods.
